(19) United States
(12) Patent Application Publication
(10) Pub. No.: US 2009/0030160 A1
(43) Pub. Date: Jan. 29, 2009

(54) Polylactic Acid Complex and Production Method Thereof

(76) Inventors: Shinichi Kanazawa, Osaka (JP); Kiyoshi Kawano, Osaka (JP)

Correspondence Address: MCDERMOTT WILL & EMERY LLP, 600 13TH STREET, N.W., WASHINGTON, DC, 20005-3096, US

(21) Appl. No.: 11/886,789

(22) PCT Filed: Mar. 14, 2006
(86) PCT No.: PCT/JP2006/304995

§ 371 Date: Sep. 20, 2007

(30) Foreign Application Priority Data
Mar. 25, 2005 (JP) 2005-090183
Aug. 30, 2005 (JP) 2005-249563
Jan. 5, 2006 (JP) 2006-000948

(51) Int. Cl. C08G 63/06

(52) U.S. Cl. 525/450

(57) ABSTRACT

This method comprises a primary cross-linking step wherein cross-linked polylactic acid is formed by cross-linking a polylactic acid molded product; an impregnation step wherein the cross-linked polylactic acid obtained in the primary cross-linking step is immersed in an impregnant at a temperature that is not lower than the glass transition temperature of polylactic acid and not higher than the melting point of polylactic acid; and a cooling step wherein the cross-linked polylactic acid, which is in the swollen state because of the impregnation of the impregnant, is cooled to temperatures equal to or lower than the glass transition temperature of polylactic acid. This method may further comprise a secondary cross-linking step following the cooling step.

### TECHNICAL FIELD

The present invention relates to a method of producing a polylactic acid complex and a polylactic acid complex produced thereby. The polylactic acid complex is used as a biodegradable product or a biodegradable component useful in fields in which plastic products including structures such as films, containers and chassis, and plastic components are used, in particular for resolving issues concerning disposal of used plastic products.

### BACKGROUND ART

Petroleum-derived synthetic polymeric materials used in a wide variety of films and containers are currently causing several social problems such as, in the disposal process alone, global warming due to heat and gases exhausted in incineration processes, adverse effects of toxic substances existing in combustion gases and combustion residues on foods and human health, and a decrease in the number of available waste burying sites.

Recently, biodegradable polymeric materials including starch and polylactic acid have been attracting attention because of their applicability as materials for resolving such problems in the disposal process of petroleum-derived synthetic polymeric materials. Biodegradable polymeric materials generate less heat than petroleum-derived synthetic polymeric materials when incinerated and maintain natural degradation and resynthesis cycles, thus exerting no adverse effect on the global environment including ecologies. Compared with other kinds of biodegradable polymeric materials, aliphatic polyester resins have recently come to particular attention because of their performance in strength and processability comparable to that of petroleum-derived synthetic polymeric materials. Polylactic acid is made of plant-derived starch unlike other kinds of aliphatic polyester resins, and the recent mass-production thereof has significantly lowered its manufacturing cost to less than that of other kinds of biodegradable polymeric materials. As a result, applications of polylactic acid have been extensively investigated.

However, a film of polylactic acid is very stiff and hardly elongates at temperatures equal to or lower than 60° C., its glass transition temperature, but is too flexible to maintain its shape at temperatures equal to or higher than 60° C., the glass transition temperature, thus being difficult to use in practice. Although the temperature of air and water in nature does not often increase to 60° C., for example, the interior space and windows of closed automobiles may be heated to such a temperature in midsummer. Therefore, the significant change in the characteristics, i.e., the fact that the material is stiff and fragile at temperatures equal to or lower than 60° C. but is too soft to maintain its shape at temperatures equal to or higher than 60° C., is a serious disadvantage.

This significant change in the characteristics is attributable to the crystalline structure of polylactic acid. More specifically, when cooled at a usual cooling rate after the melt-forming process, polylactic acid is negligibly crystallized and a large portion thereof becomes solidified in an amorphous state. The crystallized portions of polylactic acid, whose melting point is as high as 160° C., cannot easily melt, but the amorphous portions accounting for the major portion of the entire product start to move without restriction at temperatures close to 60° C., its glass transition temperature. Thus the characteristics of polylactic acid markedly change at temperatures near 60° C., the glass transition temperature.

Non-patent Document 1 describes that mixing of polylactic acid and a specific plasticizer and subsequent kneading of the mixture improve the stiffness and the fragility of the polylactic acid-based product at temperatures equal to or lower than 60° C., the glass transition temperature, thus providing the product with an impact resistance comparable to that of general-purpose plastics.

On the other hand, Japanese Unexamined Patent Application Publication No. 2003-313214 (Patent Document 1) discloses a method of cross-linking polylactic acid chains using ionizing radiation or a chemical initiator for resolving the problem that the polylactic acid product is too flexible to maintain its strength at temperatures equal to or higher than 60° C., its glass transition temperature.

However, each of the techniques described above cannot resolve by itself both the problem that occurs at temperatures equal to or higher than 60° C., the glass transition temperature, and the other problem that occurs at temperatures equal to or lower than 60° C. Also, a simple combination of these techniques, wherein a composition obtained by mixing polylactic acid with a plasticizer and then kneading the resulting mixture is cross-linked by irradiation of ionizing radiation or other means, would result in incomplete cross-linking. The reason for this is the fact that kneading the mixture of the plasticizer and the polylactic acid prior to cross-linking causes the plasticizer molecules to penetrate the gaps between the polylactic acid chains, thus preventing the polylactic acid chains from being coupled with each other, though cross-linking of the polylactic acid chains requires contacts and bonds between the chains.

Also, the increased amount of the cross-linking monomer used for cross-linking the polylactic acid chains and the increased dose of the radiation that activates the cross-linking monomer and initiates the cross-linking reactions would pose a limitation on the improvement of the strength at temperatures equal to or higher than the glass transition temperature. More specifically, the cross-linking monomer added to polylactic acid at a content ratio of as high as several tens of percent cannot stay mixed with the polylactic acid and eventually separates out. On the other hand, increasing the radiation dose would result in slow degradation of the polylactic acid, which is essentially a radiation-degradable compound, and does not improve the strength but reduces it. Therefore, this cannot resolve the above-mentioned problems.

Patent Document 1: Japanese Unexamined Patent Application Publication No. 2003-313214

Non-patent Document 1: Arakawa NEWS, Arakawa Chemical Industries, Ltd., July 2004, No. 326, PP. 2-7.

### DISCLOSURE OF INVENTION

### Problems to be Solved by the Invention

An object of the present invention is to provide a biodegradable polylactic acid complex, wherein the change in strength is small around 60° C., the glass transition temperature of polylactic acid, and a production method thereof.

More specifically, the present invention provides a biodegradable polylactic acid complex that has an excellent flexibility comparable to that of general-purpose plastics at temperatures equal to or lower than 60° C. and is unlikely to deteriorate in strength and thus can maintain its shape even at high temperatures equal to or higher than 60° C., and a production method thereof.

### Means for Solving the Problems

To achieve the objects above, the first aspect of the present invention provides a method of producing a polylactic acid complex, wherein cross-linked polylactic acid is combined with an impregnant in steps comprising:

a primary cross-linking step wherein the cross-linked polylactic acid is formed by cross-linking a polylactic acid molded product;

an impregnation step wherein the cross-linked polylactic acid is immersed in the impregnant at a temperature that is not lower than the glass transition temperature of polylactic acid and not higher than the melting point of polylactic acid so that the impregnant infiltrates the cross-linked polylactic acid; and

a cooling step wherein the cross-linked polylactic acid, which is in the swollen state because of the infiltration of the impregnant, is cooled to temperatures equal to or lower than the glass transition temperature.

As described above, in the present invention, the cross-linking reactions that occur in the primary cross-linking step render the heat resistance to the polylactic acid molded product, and then in the impregnation step, immersing the heat resistant, cross-linked polylactic acid in the liquid impregnant at a temperature that is not lower than the glass transition temperature of polylactic acid and not higher than the melting point of polylactic acid makes the impregnant infiltrate the gaps between the polylactic acid chains.

Subsequently, the interactions between the polylactic acid chains are inhibited in the cooling step, wherein the cross-linked polylactic acid is cooled to room temperature, which is equal to or lower than the glass transition temperature (60° C.), so that the resulting polylactic acid complex has an outstanding flexibility even at temperatures equal to or lower than 60° C., the glass transition temperature.

Unlike in the case where the plasticizer is added prior to the cross-linking step, in the present invention, the polylactic acid chains are cross-linked prior to being immersed in the impregnant, and thus the cross-links are almost completely conserved in the resulting polylactic acid complex. As a result, prevention of the strength loss at temperatures equal to or higher than the glass transition temperature becomes more effective than in known methods, and thus the capability of the complex to maintain its shape is enhanced. In other words, the polylactic acid components contained in the polylactic acid complex according to the present invention are coupled with each other via almost complete cross-linking, so that the complex is not deformed and can maintain its shape even at temperatures equal to or higher than 60° C., the glass transition temperature, whereas usual polylactic acid chains start to move at temperatures equal to or higher than the glass transition temperature, at which the molecular mobility exceeds the van der Waals forces and the intermolecular bonds are broken, thus deforming the complex thereof.

The steps described above are explained in more detail with reference to FIG. 1.

First, in the primary cross-linking step, a polylactic acid molded product that has been molded into a desired shape as shown in (a) is cross-linked so as to have a gel fraction of approximately 100% as shown in (b). Microscopically, the polylactic acid chains in the cross-linked polylactic acid 1 are bound to each other via the cross-links 11 as shown in FIG. 1 (c). In this state, the molded product is not deformed even at temperatures equal to or higher than the glass transition temperature because of restriction of molecular movement brought about by the cross-links. At temperatures equal to or lower than the glass transition temperature, however, the cross-linked polylactic acid becomes disadvantageous in that it is stiff, fragile and lacking in durability because of the interactions between the polylactic acid chains (indicated by the arrows in FIG. 1 (c)).

Secondly, in the impregnation step, the cross-linked polylactic acid 1 is immersed in the impregnant 2 at a temperature that is not lower than the glass transition temperature of polylactic acid and not higher than the melting point of polylactic acid, and subsequently the impregnant 2 infiltrates the gaps between the cross-linked polylactic acid chains as shown in (d).

This impregnation step effectively utilizes the above-mentioned disadvantage that, when exposed to temperatures equal to or higher than the glass transition temperature, the cross-linked polylactic acid 1 is softened to some extent because intermolecular bonds in the amorphous portions are broken. More specifically, heating the cross-linked polylactic acid 1 in the liquid impregnant 2 to temperatures equal to or higher than the glass transition temperature causes the amorphous portions of the polylactic acid to move, thus resulting in the cross-linked polylactic acid 1 swelling by infiltration of the impregnant 2 into the gaps between the polylactic acid chains.

Thirdly, the cross-linked polylactic acid 1, which is in the swollen state because of the infiltration of the impregnant 2, is cooled to room temperature in the cooling step, and as a result, the polylactic acid complex 3 according to the present invention shown in FIGS. 1 (e) and (f) is obtained.

In the polylactic acid complex 3, the network of cross-links 11 between the polylactic acid chains is infiltrated by the impregnant 2. This impregnant 2 inhibits the interactions between the polylactic acid chains and as a result, the flexibility of the complex that has occurred at temperatures equal to or higher than the glass transition temperature is maintained even after the complex is cooled to temperatures equal to or lower than the glass transition temperature. Furthermore, in the polylactic acid complex 3 according to the present invention, the cross-links 11 are formed between almost all of the polylactic acid chains. As a result, the intermolecular bonds between the polylactic acid chains are not broken and the complex thus can maintain its shape even at temperatures equal to or higher than the glass transition temperature.

As described above, the method of producing a polylactic acid complex according to the present invention includes a primary cross-linking step of producing cross-linked polylactic acid, in which it is important that almost all chains contained in the polylactic acid molded product are cross-linked to each other.

FIGS. 2 and 3 show the phenomena that would occur when the non-cross-linked polylactic acid molded product 4 is immersed in the impregnant during the impregnation step.

As shown in FIG. 2 (b), when the non-cross-linked polylactic acid molded product 4 is immersed in the impregnant 2, the molded product is dissolved in the infiltrating impregnant 2, as shown in FIG. 2 (c), because of the absence of cross-links between the polylactic acid chains, and the molded product is eventually deformed or disrupted.

Also, as shown in FIG. 3 (b), when the non-cross-linked polylactic acid molded product 4 is exposed to temperatures equal to or higher than the glass transition temperature, the amorphous portions thereof are slowly crystallized (indicated by the numeral 5 in FIG. 3 (b)) and solidified as shown in FIG. 3 (c) prior to being infiltrated by the impregnant.

Meanwhile, in the present invention, the cross-linked polylactic acid 1 in which the polylactic acid chains have been bound to each other via the cross-links 11 is immersed in the impregnant, so that the slow recrystallization of the amorphous portions does not occur.

To avoid the phenomena shown in FIGS. 2 and 3, the gel fraction of the cross-linked polylactic acid formed in the primary cross-linking step is 95% or higher, and preferably 98% or higher. More preferably, the polylactic acid chains are completely cross-linked to each other with the gel fraction being substantially 100%.

The method used to produce the cross-linked polylactic acid by cross-linking the polylactic acid molded product is not particularly limited, allowing any appropriate known method. For example, any method using ionizing radiation or a chemical initiator may be employed.

In the present invention, polylactic acid is first mixed with a cross-linking monomer (A) and the mixture is molded into a molded product having a desired shape, and then the resulting polylactic acid molded product is exposed to ionizing radiation for primary cross-linking to form a cross-linked polylactic acid. In the method of producing a polylactic acid complex according to the present invention, it is particularly preferable that no plasticizer is contained in the polylactic acid composition, which is to be molded into the polylactic acid molded product for primary cross-linking, whereas the cross-linking monomer (A) is contained therein, and that the cross-linked polylactic acid is obtained by exposing the polylactic acid molded product to ionizing radiation.

Examples of polylactic acid used in the present invention include polylactic acid consisting of L-lactic acid, polylactic acid consisting of D-lactic acid, polylactic acid obtained by polymerization of a mixture of L- and D-lactic acids, and combinations of two or more kinds thereof. It should be noted that monomers constituting polylactic acid, i.e., L- and D-lactic acids, may be chemically modified.

Polylactic acid preferably used in the present invention is homopolymer such as those described above, but lactic acid copolymer obtained by copolymerization between either a lactic acid monomer or lactide and other components that can be copolymerized with lactic acid or lactide may also be used. Examples of the abovementioned “other components” used to form the copolymer include hydroxycarboxylic acids such as glycolic acid, 3-hydroxybutyric acid, 5-hydroxyvaleric acid and 6-hydroxycaproic acid; dicarboxylic acids such as succinic acid, adipic acid, sebacic acid, glutaric acid, decanedicarboxylic acid, terephthalic acid and isophthalic acid; polyvalent alcohols such as ethylene glycol, propanediol, octanediol, dodecanediol, glycerin, sorbitan and polyethylene glycol; and lactones such as glycolide, ε-caprolactone and δ-butyrolactone.

The kind of the cross-linking monomer (A) mixed with polylactic acid prior to primary cross-linking is not particularly limited as long as it can serve as a cross-linker in response to the irradiation of ionizing radiation. For example, an acrylic-, a methacrylic- or an allylic-type cross-linking monomer may be used.

Examples of the acrylic- or methacrylic-type cross-linking monomer include 1,6-hexanediol di(meth)acrylate, 1,4-butanediol di(meth)acrylate, trimethylolpropane tri(meth)acrylate, ethylene-oxide-modified trimethylolpropane tri(meth)acrylate, propylene-oxide-modified trimethylolpropane tri(meth)acrylate, ethylene-oxide-modified bisphenol A di(meth)acrylate, diethylene glycol di(meth)acrylate, dipentaerythritol hexaacrylate, dipentaerythritol monohydroxy pentaacrylate, caprolactone-modified dipentaerythritol hexaacrylate, pentaerythritol tri(meth)acrylate, pentaerythritol tetra(meth)acrylate, polyethyleneglycol di(meth)acrylate, tris(acryloxyethyl)isocyanurate and tris(methacryloxyethyl)isocyanurate.

Examples of the allylic-type cross-linking monomer include triallylisocyanurate, trimethallylisocyanurate, triallylcyanurate, trimethallylcyanurate, diallylamine, triallylamine, diacryl chlorentate, allyl acetate, allyl benzoate, allyl dipropyl isocyanurate, allyl octyl oxalate, allyl propyl phthalate, bityl allyl maleate, diallyl adipate, diallyl carbonate, diallyl dimethyl ammonium chloride, diallyl fumarate, diallyl isophthalate, diallyl malonate, diallyl oxalate, diallyl phthalate, diallyl propyl isocyanurate, diallyl sebacate, diallyl succinate, diallyl terephthalate, diallyl tartrate, dimethyl allyl phthalate, ethyl allyl maleate, methyl allyl fumarate, methyl methallyl maleate and diallyl monoglycidyl isocyanurate.

A cross-linking monomer (A) preferably used in the present invention is the allylic-type cross-linking monomer, which exerts excellent cross-linking performance even when used at a relatively low concentration. In particular, triallylisocyanurate (hereinafter, TAIC) displays excellent cross-linking performance for polylactic acid, thus being particularly preferably used. In addition, triallylcyanurate, which can be easily transformed into and reproduced from TAIC by heating, provides the substantially same effect as TAIC.

The abovementioned cross-linking monomer (A) is mixed with 100 parts by weight of polylactic acid preferably at a content ratio of 4 to 15 parts by weight. The reason why the content ratio of the cross-linking monomer (A) is at least 4 parts by weight is the concern that content ratios of the cross-linking monomer (A) lower than 4 parts by weight cannot exert cross-linking performance sufficiently, thus resulting in a reduced strength of the complex at high temperatures equal to or higher than 60° C., or in the worst case, the shape of the complex cannot be maintained. On the other hand, the reason why the content ratio of the cross-linking monomer (A) is not higher than 15 parts by weight is the fact that content ratios of the cross-linking monomer (A) higher than 15 parts by weight make it difficult to mix the full amount of the cross-linking monomer (A) with polylactic acid uniformly, thus offering only a slight advantage in the cross-linking effect.

To ensure the capability of maintaining the shape of the complex at high temperatures equal to or higher than 60° C., the content ratio of the cross-linking monomer (A) is preferably 5 parts by weight or more. To increase the content ratio of polylactic acid so as to improve the biodegradability, the content ratio of the cross-linking monomer (A) is preferably 10 parts by weight or less.

The composition used to form the polylactic acid molded product in the present invention may contain additional ingredients other than the polylactic acid and the cross-linking monomer (A), unless the ingredient has an adverse effect on achieving the objects of the present invention.

For example, any biodegradable resin other than polylactic acid may be added in the composition. Examples of the biodegradable resin other than polylactic acid include synthetic biodegradable resins such as lactone resins, aliphatic polyesters and polyvinyl alcohol, and natural biodegradable resins such as natural linear polyester resins, e.g., polyhydroxy butyrate/valerate.

Also, a biodegradable synthetic polymer and/or a natural polymer may be mixed with the composition as far as the addition of the polymer does not impair the fusing characteristics. Examples of the biodegradable synthetic polymer include cellulose esters such as cellulose acetate, cellulose butyrate, cellulose propionate, cellulose nitrate, cellulose sulfate, cellulose acetate butyrate and cellulose acetate nitrate; and polypeptides such as polyglutamic acid, polyaspartic acid and polyleucine. Examples of the natural polymer include starch, e.g., raw starch such as maize starch, wheat starch and rice starch, and processed starch such as acetate starch, methyl ether starch and amylose.

The composition may further contain resin components other than the biodegradable resin, curable oligomer, additives such as several kinds of stabilizers, flame retardants, antistatic agents, fungicides and tackifiers, glass fiber, glass beads, metal powder, inorganic or organic fillers such as talc, mica and silica, and coloring agents such as pigment and dye.

The abovementioned polylactic acid molded product is obtained by molding a composition containing the polylactic acid, the cross-linking monomer (A) and other desired ingredients into a desired shape.

The method of molding is not particularly limited, allowing any appropriate known method. For example, a known molding machine such as an extruder, a compression molding machine, a vacuum forming machine, a blow molding machine, a flat die extruder, an injection molding machine and an inflation molding machine may be used.

The cross-linked polylactic acid is obtained in the above-mentioned primary cross-linking step by exposing the resulting polylactic acid molded product to ionizing radiation so that the polylactic acid chains are cross-linked to each other.

Gamma-rays, X-rays, β-rays and α-rays may be used as the ionizing radiation, with γ-ray irradiation using Cobalt-60 and electron irradiation using an electron linear accelerator being preferable in industrial manufacturing.

The irradiation of ionizing radiation is conducted preferably in an air-free inert gas or under vacuum, because inactivation of activated species generated by the irradiation of ionizing radiation due to binding thereof to oxygen in the air would reduce the efficiency of cross-linking reactions.

The ionizing radiation dose is preferably in the range of 50 kGy to 200 kGy.

Depending on the content ratio of the cross-linking monomer (A), cross-linking of polylactic acid chains may be observed even when the ionizing radiation dose is in the range of 1 kGy to 10 kGy. However, to cross-link almost all of polylactic acid chains, the ionizing radiation dose is preferably 50 kGy or higher. Furthermore, to allow the polylactic acid molded product immersed in the liquid impregnant to swell uniformly while avoiding deformation thereof, the ionizing radiation dose is more preferably 80 kGy or higher.

At the same time, the ionizing radiation dose is preferably 200 kGy or less because doses higher than 200 kGy promote decomposition of polylactic acid resin, which is radiation-degradable alone, rather than the cross-linking reactions. The ionizing radiation dose is preferably 150 kGy or lower, and more preferably 100 kGy or lower.

In addition, the cross-linked polylactic acid can be obtained not only by the irradiation of ionizing radiation, but also by mixing polylactic acid, a cross-linking monomer (A) and a chemical initiator, molding the mixture into a molded product having a desired shape, and then heating the molded product to temperatures at which the chemical initiator is thermally decomposed.

Examples of the cross-linking monomer (A) include the same compounds used in the abovementioned mode of the invention.

Examples of the chemical initiator include peroxide catalysts that generate peroxide radicals when thermally decomposed, such as dicumyl peroxide, propionitrile peroxide, benzoyl peroxide, di-t-butyl peroxide, diacyl peroxide, pelargonyl peroxide, myristoyl peroxide, t-butyl peroxybenzoate and 2,2′-azobisisobutyronitrile, and any other polymerization initiators.

Temperature conditions used for cross-linking may be appropriately modified depending on the kind of the chemical initiator used. As in the case using radiation, the cross-linking is conducted preferably in an air-free inert gas or under vacuum.

The cross-linked polylactic acid obtained in the above-mentioned primary cross-linking step is, as described earlier, immersed in a liquid impregnant at a temperature that is not lower than the glass transition temperature of polylactic acid and not higher than the melting point of polylactic acid in the impregnation step.

The kind of the impregnant used is not particularly limited as long as the impregnant is in the liquid state at room temperature or melts in the liquid state at a temperature that is not lower than the glass transition temperature of polylactic acid and not higher than the melting point of polylactic acid though it is in the solid state at a room temperature. More specifically, examples of the impregnant include a plasticizer that is commonly used in the technical field of the present invention and satisfies the requirements described above.

Useful materials such as drugs, agrichemicals, pharmaceuticals and foods may be used as the impregnant. When used as the impregnant, molecules of the useful material are supported by the polylactic acid cross-linking network in the polylactic acid complex according to the present invention, thus contributing to construction of a sustained-release system from which the molecules of the useful material are slowly released as the polylactic acid is biodegraded.

In the present invention, polylactic acid is subjected to primary cross-linking using radiation or other cross-linking means before being immersed in an impregnant, and thus there is no need to consider characteristics of the impregnant such as the resistance to radiation and other cross-linking means and the inhibition of cross-linking reactions when selecting the impregnant. Any impregnant that is compatible with polylactic acid may be used, and the cross-linking status of polylactic acid can be controlled independently of the kind of impregnant.

The impregnant preferably has an affinity for polylactic acid because it should infiltrate the polylactic acid. Therefore, the impregnant preferably has some degree of polarity and a rather low molecular weight, and the most suitable impregnant is polylactic acid and derivatives thereof. More specifically, the impregnant containing at least one of the following (a) to (g) is suitably used:

(a) polar monovalent alcohols, monovalent carboxylic acids, ketones or lactones;

(b) polar aprotic solvents such as N,N-dimethylformamide and dimethylsulfoxide (DMSO);

(c) polar aromatic compounds such as styrene;

(d) allylic compounds having a triazine ring;

(e) plasticizers containing a polylactic acid derivative or a rosin derivative;

(f) plasticizers containing a dicarboxylic acid derivative; and

(g) plasticizers containing a glycerin derivative.

In particular, to maintain an excellent biodegradability of the polylactic acid complex according to the present invention, the impregnant is preferably biodegradable. More specifically, small aliphatic polyesters such as polylactic acid and derivatives thereof, dicarboxylic acid derivatives, glycerin derivatives, lactones, alcohols and other biodegradable plasticizers are suitable.

Among alcohols, monovalent alcohols having some degree of polarity is preferably used as the impregnant, whereas diols, divalent alcohols (such as ethylene glycol), and glycerin, a trivalent alcohol, are nonpolar, thus being unlikely to infiltrate the polylactic acid molded product.

The polar monovalent alcohol may be a lower alcohol or a higher alcohol.

Examples of the lower alcohol include methyl alcohol, ethyl alcohol, isopropyl alcohol, n-butyl alcohol, sec-butyl alcohol, tert-butyl alcohol and n-pentyl alcohol, but are not particularly limited as long as the number of carbon atoms thereof is five or smaller.

Industrially available examples of the higher alcohol include nonyl alcohol, decyl alcohol, lauryl alcohol, myristyl alcohol, cetyl alcohol, stearyl alcohol and oleyl alcohol, but are not particularly limited as long as the number of carbon atoms thereof is six or larger. Alcohol mixtures such as sperm alcohol and jojoba alcohol, and reduced alcohols such as beef tallow alcohol and palm alcohol may also be used.

In the present invention, ethyl alcohol, isopropyl alcohol, t-butyl alcohol or n-pentyl alcohol is particularly preferably used.

Examples of the abovementioned monovalent carboxylic acid include C1 acetic acid. Additionally, known aliphatic monocarboxylic acid, alicyclic monocarboxylic acid, aromatic monocarboxylic acid or others may also be used as the monovalent carboxylic acid.

Examples of the aliphatic monocarboxylic acid include linear or branched fatty acids wherein the number of carbon atoms is in the range of 1 to 32, preferably in the range of 1 to 20, and more preferably in the range of 1 to 10. More specifically, examples of the aliphatic monocarboxylic acid include saturated fatty acids such as acetic acid, propionic acid, butyric acid, valeric acid, caproic acid, enanthic acid, caprylic acid, pelargonic acid, capric acid, 2-ethyl-hexane carboxylic acid, undecylic acid, lauric acid, tridecyl acid, myristic acid, pentadecyl acid, palmitic acid, heptadecyl acid, stearic acid, nonadecanoic acid, arachidic acid, behenic acid, lignoceric acid, cerotinic acid, heptacosanoic acid, montanic acid, melissic acid and lacceric acid; and unsaturated fatty acids such as undecylenic acid, oleic acid, sorbic acid, linoleic acid, linolenic acid and arachidonic acid. These compounds may have additional substituents.

Examples of the alicyclic monocarboxylic acid include carboxylic acids such as cyclopentanecarboxylic acid, cyclohexanecarboxylic acid, cyclooctanecarboxylic acid, bicyclononanecarboxylic acid, bicyclodecanecarboxylic acid, norbornene carboxylic acid, and adamantane carboxylic acid, and derivatives thereof.

Examples of the aromatic monocarboxylic acid include benzoic acid; compounds obtained by adding an alkyl group to a benzene ring of benzoic acid, such as toluic acid; aromatic monocarboxylic acid having two or more benzene rings, such as biphenylcarboxylic acid, naphthalenecarboxylic acid and tetralincarboxylic acid; and derivatives thereof.

Furthermore, preferable examples of the abovementioned ketones include diethyl ketone. Besides the diethyl ketone, examples of the ketones may include acetone, methyl ethyl ketone, 2-pentanone, 3-pentanone, 2-hexanone, methyl isobutyl ketone, 2-heptanone, 4-heptanone and phorone. Among these ketones, methyl ethyl ketone is particularly preferably used.

Specific examples of the lactones include β-propiolactone, β-butyrolactone, γ-butyrolactone, γ-valerolactone, δ-valerolactone, δ-caprolactone and ε-caprolactone; methylcaprolactones such as 4-methylcaprolactone, 3,5,5-trimethylcaprolactone and 3,3,5-trimethylcaprolactone; cyclic monoesters of hydroxycarboxylic acid such as β-methyl-8-valerolactone, enantholactone and laurolacton; cyclic diesters of hydroxycarboxylic acid such as glycolide, L-lactide and D-lactide; and cyclic ester-ethers such as 1,3-dioxolan-4-one, 1,4-dioxan-3-one and 1,5-dioxepan-2-one.

In the present invention, γ-butyrolactone or ε-caprolactone is particularly preferably used.

Triazine is a six-membered heterocycle containing three nitrogen atoms therein, and any compound that has this structure may be used without any limitation as the triazine. Examples of the triazine include tris(2,3-epoxypropyl)isocyanurate, tris(2-hydroxyethyl)isocyanurate, trimethallylisocyanurate, tri(2,3-dibromopropyl)isocyanurate, triallylisocyanurate, triallylcyanurate, isocyanuric acid, methyl isocyanurate, ethyl isocyanurate, isoammeline, isomelamine and isoammelide, with triallylisocyanurate being particularly preferable.

Examples of the rosins include raw material rosins such as gum rosin, wood rosin and tall oil rosin; stabilized rosin and polymerized rosin obtained via disproportionation or hydrotreatment of the raw material rosins; as well as rosin esters, strengthened rosin esters, rosin phenols and rosin-modified phenol resins.

In the present invention, “Lactcizer GP-2001” manufactured by Arakawa Chemical Industries, Ltd., a plasticizer containing a rosin derivative, is particularly preferably used.

Examples of the abovementioned aliphatic polyesters include polycondensations and copolycondensations containing an aliphatic diol as the main ingredient and an aliphatic dicarboxylic acid or a derivative thereof; and copolycondensations containing an aliphatic diol, an aliphatic dicarboxylic acid or a derivative thereof, and hydroxycarboxylic acid, and more specifically, include polymers and copolymers synthesized using at least one selected from the group including α-hydroxycarboxylic acids (such as glycolic acid, lactic acid and hydroxybutyric acid), hydroxydicarboxylic acids (such as malic acid) and hydroxytricarboxylic acids (such as citric acid), and mixtures thereof. In particular, polylactic acid is preferably used as the aliphatic polyester.

The molecular weight of the aliphatic polyester is preferably smaller than that of the polylactic acid constituting the polylactic acid complex. More specifically, the molecular weight of the aliphatic polyester is 1×10⁵ or less, preferably 1×10⁴ or less, and more preferably in the range of 1×10₂ to 1×10³.

Any known compound obtained via chemical modifications of the aliphatic polyester may be used as the aliphatic polyester derivative. “Lactcizer GP-4001” manufactured by Arakawa Chemical Industries, Ltd., a plasticizer containing a polylactic acid derivative, is particularly preferably used.

Examples of the dicarboxylic acid derivative include ester bodies of dicarboxylic acids, metallic salts of dicarboxylic acids and anhydrides of dicarboxylic acids.

Examples of the dicarboxylic acids include linear or branched, saturated or unsaturated fatty dicarboxylic acids whose number of carbon atoms is in the range of 2 to 50, and in particular, is in the range of 2 to 20; aromatic dicarboxylic acids whose number of carbon atoms is in the range of 8 to 20; and polyether dicarboxylic acids whose number average molecular weight is 2000 or smaller, and in particular, is 1000 or smaller. Among these dicarboxylic acids, aliphatic dicarboxylic acids whose number of carbon atoms is in the range of 2 to 20, such as oxalic acid, malonic acid, succinic acid, glutaric acid, adipic acid, sebacic acid and decanedicarboxylic acid; and aromatic dicarboxylic acids such as phthalic acid, terephthalic acid and isophthalic acid.

As the dicarboxylic acid derivative, ester bodies of a dicarboxylic acid are preferably used. Examples of the ester bodies of dicarboxylic acids include bis(methyl diglycol)adipate, bis(ethyl diglycol)adipate, bis(butyl diglycol)adipate, methyl diglycol butyl diglycol adipate, methyl diglycol ethyl diglycol adipate, ethyl diglycol butyl diglycol adipate, dibenzyl adipate, benzyl methyl diglycol adipate, benzyl ethyl diglycol adipate, benzyl butyl diglycol adipate, bis(methyl diglycol)succinate, bis(ethyl diglycol)succinate, bis(butyl diglycol)succinate, methyl diglycol ethyl diglycol succinate, methyl diglycol butyl diglycol succinate, ethyl diglycol butyl diglycol succinate, dibenzyl succinate, benzyl methyl diglycol succinate, benzyl ethyl diglycol succinate, benzyl butyl diglycol succinate, ethyl methyl diglycol adipate, ethyl butyl diglycol adipate, butyl methyl diglycol adipate, butyl butyl diglycol adipate, ethyl methyl diglycol succinate, ethyl ethyl diglycol succinate, ethyl butyl diglycol succinate, butyl methyl diglycol succinate, butyl ethyl diglycol succinate, butyl butyl diglycol succinate, dimethyl phthalate, diethyl phthalate, dibutyl phthalate, bis(2-ethylhexyl)phthalate, di-n-octyl phthalate, diisodecyl phthalate, butyl benzyl phthalate, diisononyl phthalate, and ethylphthalylethylene glycolate.

As the dicarboxylic acid derivative, esterified bodies of a dicarboxylic acid as represented by acetylated bodies of a dicarboxylic acid such as oxalic acid, malonic acid, succinic acid, glutaric acid, adipic acid and phthalic acid. In the present invention, “DAIFFATY-101” manufactured by Daihachi Chemical Industry Co., Ltd., an adipate, is particularly preferably used.

Examples of the glycerin derivatives include ones obtained by esterifying glycerin. More specifically, fatty acid monoglycerides, fatty acid diglycerides, and fatty acid triglycerides are included.

Examples of fatty acids constituting the esters described above include saturated or unsaturated fatty acids whose number of carbon atoms is in the range of 2 to 22, and in particular, include acetic acid, propionic acid, butyric acid (butanoic acid), isobutyric acid, valeric acid (pentanoic acid), isovaleric acid, caproic acid (hexanoic acid), heptanoic acid, caprylic acid, nonanoic acid, capric acid, isocapric acid, lauric acid, myristic acid, palmitic acid, stearic acid, behenic acid, 12-hydroxystearic acid, oleic acid, linoleic acid, erucic acid and 12-hydroxyoleic acid. Two kinds of fatty acids constituting the fatty acid diglycerides may be identical to or different from each other, and that is also the case for three kinds of fatty acids constituting the fatty acid triglycerides.

In the present invention, acetylated glycerins such as triacetyl glyceride (also known as Triacetin) and “RIKEMAL PL” products manufactured by Riken Vitamin Co., Ltd., an acetylated monoglyceride, are particularly preferably used.

In the impregnation step described earlier, any temperature that is not lower than the glass transition temperature of polylactic acid and not higher than the melting point of polylactic acid may be employed as the temperature of the impregnant in which the cross-linked polylactic acid is immersed, as long as the impregnant is in the liquid state at the temperature, depending on the kind of the impregnant or other conditions. The higher the temperature is, the faster the impregnant is diffused into the polylactic acid cross-linking network. However, in general, the temperature is preferably in the range of 80° C. to 120° C.

Also, the impregnation time is not particularly limited. However, the time required for diffusion is usually proportional to the square of the thickness and thus the impregnation time for the cross-linked polylactic acid with a thickness of 1 mm or smaller is in the range of 5 minutes to 120 minutes, and preferably in the range of 30 minutes to 90 minutes, whereas the impregnation time for one with a thickness of a few millimeters or larger is in the range of 10 hours to 20 hours.

In the cooling step described earlier, the cross-linked polylactic acid that is in the swollen state because of the infiltration of the impregnant is cooled to room temperature, which is not higher than the glass transition temperature (60° C.) of polylactic acid, and as a result, the polylactic acid complex according to the present invention, wherein the polylactic acid chains and the impregnant molecules are coupled with each other, is obtained.

In the present invention, a step of further cross-linking the cross-linked polylactic acid obtained in the primary cross-linking step, i.e., the secondary cross-linking step, may be carried out after the above-mentioned steps in which the cross-linked polylactic acid is immersed in a cross-linking monomer (B) serving as the impregnant in the impregnation step described above and then the cross-linked polylactic acid containing the cross-linking monomer (B) is cooled in the cooling step described above.

As a result of using the cross-linking monomer (B) as the impregnant and further cross-linking the cross-linked polylactic acid containing the cross-linking monomer (B) as described above, the cross-linking monomer (B) molecules are cross-linked to each other and to the polylactic acid chains.

In other words, the primary cross-linking step couples the polylactic acid chains with each other via primary cross-linking, and then the secondary cross-linking step makes the cross-linking network more complicated by coupling the cross-linking monomer molecules with each other or with the polylactic acid chains via secondary cross-linking.

This combination of two cross-linking steps enables the polylactic acid complex to maintain its strength, which has been achieved at temperatures equal to or lower than 60° C., the glass transition temperature, even at high temperatures equal to or higher than 60° C., as well as prevents the infiltrating cross-linking monomer from being separated out through binding molecules thereof via cross-linking.

The abovementioned primary cross-linking step, impregnation step, cooling step and secondary cross-linking step are explained below with reference to FIG. 4.

First, polylactic acid is mixed with a cross-linking monomer (A), and then the mixture is molded into a molded product having a desired shape as shown in (a). The resulting polylactic acid molded product is subjected to primary cross-linking so as to have a gel fraction of approximately 100% as shown in (b). Microscopically, the polylactic acid chains in the cross-linked polylactic acid 1 are bound to each other via the cross-links 11 as shown in (c). In this state, the molded product is not deformed even at temperatures equal to or higher than the glass transition temperature because of restriction of molecular movement brought about by the cross-links.

Secondly, in the impregnation step, the cross-linked polylactic acid 1 is immersed in a liquid cross-linking monomer (B) 2 at a temperature that is not lower than the glass transition temperature of polylactic acid and not higher than the melting point of polylactic acid, and subsequently the cross-linking monomer (B) 2 infiltrates the gaps between the cross-linked polylactic acid chains as shown in (d).

This impregnation step effectively utilizes the above-mentioned disadvantage that, when exposed to temperatures equal to or higher than the glass transition temperature, the cross-linked polylactic acid 1 is softened to some extent because intermolecular bonds in the amorphous portions are broken. More specifically, heating the cross-linked polylactic acid 1 in the liquid cross-linking monomer (B) 2 to temperatures equal to or higher than the glass transition temperature causes the amorphous portions of the polylactic acid to move, thus resulting in the cross-linked polylactic acid 1 swelling by infiltration of the cross-linking monomer (B) 2 into the gaps between the polylactic acid chains.

Thirdly, in the cooling step, the cross-linked polylactic acid is cooled to room temperature, which is not higher than the glass transition temperature of polylactic acid, and as a result, the polylactic acid complex 3 shown in (e) and (D) is obtained. In this state, molecules of the cross-linking monomer (B) 2 simply exist in the gaps between the polylactic acid chains and are not bound to the chains.

Then, in the secondary cross-linking step, the molded product is further cross-linked using ionizing radiation or other means. As a result, molecules of the infiltrating cross-linking monomer (B) are bound to each other via cross-links 12 and at the same time, they are bound also to the polylactic acid chains via graft cross-linking, thus producing the polylactic acid complex 10 having a more complicated cross-linking network as shown in (g) and (h).

In this way, the combination of two cross-linking steps, primary cross-linking and secondary cross-linking, makes the cross-linking network more complicated and thereby improves the strength of the resulting polylactic acid complex 10. Thus the polylactic acid complex 10 has a sufficient strength for maintaining its shape even at temperatures equal to or higher than 60° C., the glass transition temperature.

Unlike in the primary cross-linking step, the gel fraction of the complex obtained in the secondary cross-linking step does not always have to be 100%. Therefore, the content ratio of the cross-linking monomer (B) in which the polylactic acid molded product is immersed in the impregnation step is determined in accordance with the cross-linking density of the polylactic acid obtained in the primary cross-linking step and the affinity of the cross-linking monomer (B) for polylactic acid.

The content ratio of the cross-linking monomer (B) can be controlled by, for example, raising or lowering the cross-linking density via changing the amount of the cross-linking monomer (A) contained in the polylactic acid molded product, the ionizing radiation dose used for cross-linking, or other parameters.

The method of the abovementioned secondary cross-linking is not particularly limited and any known method is allowed, with the irradiation of ionizing radiation being preferable.

The method of cross-linking using the ionizing radiation is similar to that used in the primary cross-linking step. However, the ionizing radiation dose may be smaller than that required in the primary cross-linking step though it depends on the amount of the cross-linking monomer used in the impregnation step.

More specifically, the ionizing radiation dose used in the secondary cross-linking step is in the range of 1 kGy to 200 kGy, preferably in the range of 10 kGy to 200 kGy, and more preferably in the range of 30 kGy to 200 kGy.

The kind of the cross-linking monomer (B) used is not particularly limited as long as the cross-linking monomer (B) is the liquid state at room temperature or melts in the liquid state at a temperature that is not lower than the glass transition temperature of polylactic acid and not higher than the melting point of polylactic acid though it is in the solid state at a room temperature.

Examples of the cross-linking monomer (B) include acrylic-, methacrylic acid-, styrene-, allylic- and lactone-type monomers.

To improve the cross-linking density of polylactic acid, the allylic-type cross-linking monomer described above is preferably used.

To improve the strength of the resulting complex at temperatures equal to or higher than the glass transition temperature of polylactic acid, an acrylic-type or a methacrylic acid-type monomer is preferably used. In particular, the acrylic-type monomer, which is stiff in the polymerized state, improves the heat resistance at high temperatures. The complex containing the acrylic-type monomer can be used as an optical material because it is still transparent even after the coupling process.

To add graft chains to polylactic acid so as to provide starting points of graft polymerization and introduction of functional groups into the polylactic acid, a styrene-type cross-linking monomer is also useful.

To further improve the biodegradability of the resulting cross-linked polylactic acid complex, the lactone-type cross-linking monomer is preferably used.

Examples of the abovementioned acrylic- or methacrylic-type cross-linking monomer include (meth)acrylic acid, methyl (meth)acrylate, 1,6-hexanediol di(meth)acrylate, 1,4-butanediol di(meth)acrylate, trimethylolpropane tri(meth)acrylate, ethylene-oxide-modified trimethylolpropane tri(meth)acrylate, propylene-oxide-modified trimethylolpropane tri(meth)acrylate, ethylene-oxide-modified bisphenol A di(meth)acrylate, diethylene glycol di(meth)acrylate, dipentaerythritol hexaacrylate, dipentaerythritol monohydroxy pentaacrylate, caprolactone-modified dipentaerythritol hexaacrylate, pentaerythritol tri(meth)acrylate, pentaerythritol tetra(meth)acrylate, polyethyleneglycol di(meth)acrylate, tris(acryloxyethyl)isocyanurate and tris(methacryloxyethyl)isocyanurate.

Examples of the abovementioned styrene-type cross-linking monomer include styrene; compounds having functional groups mainly at its para-positions, such as p-methyltoluene; styrene sulfonate, chlorostyrene and α-methylstyrene.

Examples of the abovementioned lactone-type cross-linking monomer include ε-caprolactone, methylcaprolactones such as 4-methylcaprolactone, 3,5,5-trimethylcaprolactone and 3,3,5-trimethylcaprolactone, β-propiolactone, γ-butyrolactone, 6-valerolactone and enantholactone.

The present invention provides a polylactic acid complex produced through the abovementioned primary cross-linking step, impregnation step and cooling step.

In the thus-prepared polylactic acid complex according to the present invention, the impregnant 2 infiltrates the polylactic acid cross-linking network 11 as shown in FIG. 1 (e) and (f).

Also, in the polylactic acid complex according to the present invention, it is preferable that substantially 100% of the polylactic acid component is cross-linked. Therefore, the gel fraction of the cross-linked polylactic acid before being immersed in the impregnant is 95% or higher, preferably 98% or higher, and more preferably substantially 100%.

Even when the gel fraction is virtually larger than 100%, the number of cross-linking points, or the cross-linking density, is also important because the content of the impregnant can be controlled by increasing this cross-linking density. This is based on the fact that the more precise the structure of the cross-linking network is, the more unlikely to change the structure and its volume are. Thus the content of the impregnant can be controlled by raising or lowering the cross-linking density via changing the amount of the cross-linking monomer, the ionizing radiation dose used for cross-linking, or other parameters.

The content ratio of the impregnant existing in the polylactic acid complex cooled after the primary cross-linking step is preferably in the range of 5% to 60%. The reason why the content ratio of the impregnant is at least 5% is the fact that the flexibility of the polylactic acid complex at temperatures equal to or lower than the glass transition temperature is ensured when the content ratio of the impregnant falls within this range. To further improve the flexibility, the content ratio of the impregnant is preferably 10% or higher, and more preferably 20% or higher.

The reason why the content ratio of the impregnant is not larger than 60% is the concern that separating out of the impregnant, so-called bleed, may occur when the content ratio of the impregnant is larger than 60%. Preferably, the content ratio of the impregnant is 50% or lower.

The present invention also provides a polylactic acid complex that has been cross-linked twice through the primary cross-linking step, impregnation step, cooling step and secondary cross-linking step.

This polylactic acid complex is produced by coupling polylactic acid chains with each other via primary cross-linking in the primary cross-linking step, immersing the cross-linked polylactic acid in the cross-linking monomer (B) in the impregnation step, and then coupling the infiltrating cross-linking monomer molecules with each other and with the polylactic acid chains via graft cross-linking in the secondary cross-linking step to make the cross-linking network more complicated.

This dense and complicated cross-linking network provides the heat resistance with which the complex can maintain its shape even at high temperatures equal to or higher than 60° C., the glass transition temperature of polylactic acid.

In the abovementioned polylactic acid complex that has been cross-linked twice, the content ratio of the cross-linking monomer (B) in polylactic acid is preferably in the range of 5 wt % to 50 wt %.

The reason why the content ratio of the cross-linking monomer is at least 5 wt % is the concern that, when the content ratio of the cross-linking monomer is smaller than 5 wt %, improvement in the cross-linking density due to the presence of the cross-linking monomer may be insufficient. At the same time, the content ratio of the cross-linking monomer is not larger than 50 wt % in order to prevent bleed, separating out of the cross-linking monomer, from occurring.

Any of the polylactic acid complex that has been cross-linked once in the primary cross-linking step and the other polylactic acid complex that has been cross-linked twice in the primary and secondary cross-linking steps can be produced so as to display no thermal absorption at the glass transition temperature of polylactic acid and to exhibit no thermal absorption associated with crystal melting at temperatures around the melting point of polylactic acid in the calorimetrical analysis performed over the temperature range of 40° C. to 200° C. using a differential scanning calorimeter.

In such a polylactic acid complex, an extreme change in strength occurring at temperatures around the glass transition temperature as observed in a known polylactic acid molded product, which is caused by amorphous portions of the molded product that rapidly start to move without restriction at that temperature, is unlikely to occur.

### EFFECTS OF THE INVENTION

The polylactic acid complex according to the present invention can consistently maintain its shape using the polylactic acid cross-linking network even at high temperatures higher than 60° C., the glass transition temperature of polylactic acid. At temperatures equal to or lower than the glass transition temperature of polylactic acid, the polylactic acid complex exhibits an excellent flexibility and elongation because the impregnant infiltrating the polylactic acid cross-linking network inhibits the interactions between the polylactic acid chains. Consequently, the polylactic acid complex can be utilized in general applications using plastics, in particular, ones using flexible polyvinyl chloride, such as rubber suction cups. It is suitably used also as a shape-memory material, which requires both the flexibility and the shape-memory property.

In particular, the polylactic acid complex according to the present invention produced by a method, wherein the cross-linking monomer (B) is used as the impregnant in which the cross-linked polylactic acid obtained in the primary cross-linking step is immersed and then chains of the cross-linked polylactic acid containing the cross-linking monomer (B) are further cross-linked in the secondary cross-linking step, would have the cross-linking network in which the polylactic acid chains are cross-linked to each other, the added cross-linking monomer molecules are cross-linked to each other, and the polylactic acid chains and the cross-linking monomer molecules are also cross-linked. The high cross-linking density achieved in this method enables the polylactic acid cross-linking network to maintain its shape consistently even at high temperatures higher than 60° C., the glass transition temperature of polylactic acid.

This polylactic acid complex is also transparent in spite of the high graft ratio. Thus it can be said that the polylactic acid complex according to the present invention overcomes the disadvantages of polylactic acid while retaining the advantages thereof, thus greatly enhancing the applicability of biodegradable resins as substitutes of petroleum-derived synthetic general-purpose plastics, i.e., for the original object of the biodegradable resins.

The biodegradability of the polylactic acid complex according to the present invention significantly reduces the adverse effects of the product on ecologies in the natural world, thus resolving the disposal issues unavoidable in known plastics. Moreover, the unique flexibility of the polylactic acid complex according to the present invention, which has not been achieved by other kinds of biodegradable resins, may enable polylactic acid to be applied in fields where the material has not been able to be utilized. Also, this material has no adverse effects on living bodies, and thus can be employed for manufacturing medical devices used in and out of living bodies, such as syringes and catheters.

Considering the biodegradability and biocompatibility or in vivo degradability of polylactic acid, the polylactic acid complex according to the present invention can be applied to a sustained-release system of useful materials utilizing the containability thereof. In other words, molecules of the useful materials, such as drugs and pharmaceuticals, coupled with polylactic acid chains are slowly released as the polylactic acid is degraded. Thus the polylactic acid complex according to the present invention can be used in a wide variety of fields and technologies.

Furthermore, the present invention exhibits a gel-like structure in which molecules of a polar solvent, such as methanol and dimethylsulfoxide (DMSO), are contained in the cross-linking network thereof. Therefore, it can be used as a molecular sieve in gel filtration, liquid chromatography or other applications, and also can be applied to separation analysis techniques when the cross-linking network structure thereof is modified.

The present invention also provides a method of copolymerizing polylactic acid with a general-purpose graft monomer used in various fields, such as styrene, acrylic acid and methacrylic acid, to make these materials more complicated or to enhance the functionality of polylactic acid, thus having applicability in a wide range of technical fields.

### BRIEF DESCRIPTION OF THE DRAWINGS

FIG. 1 is a schematic diagram showing a production process of the polylactic acid complex according to the present invention.

FIG. 2 is a schematic diagram showing a phenomenon that occurs when a non-cross-linked polylactic acid molded product is immersed in an impregnant.

FIG. 3 is a schematic diagram showing a phenomenon that occurs when a non-cross-linked polylactic acid molded product is immersed in an impregnant.

FIG. 4 is a schematic diagram showing a production process of the polylactic acid complex according to the present invention.

FIG. 5 is an illustration of a test device used in a heat deformation test.

FIG. 6 is a graph that shows the results of the bleed evaluation test.

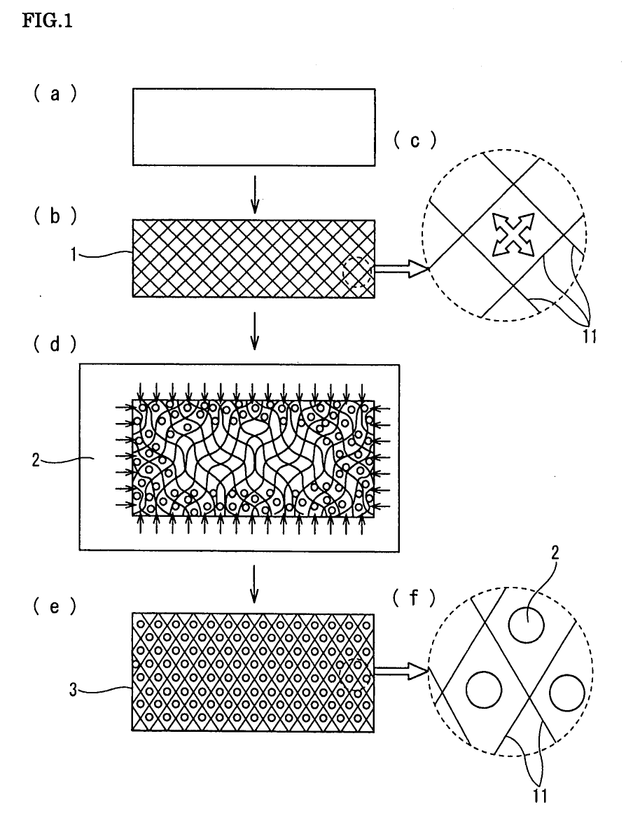

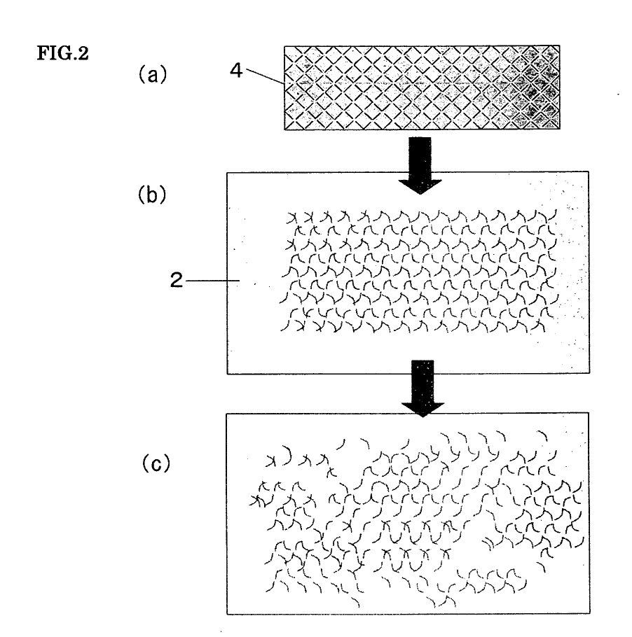

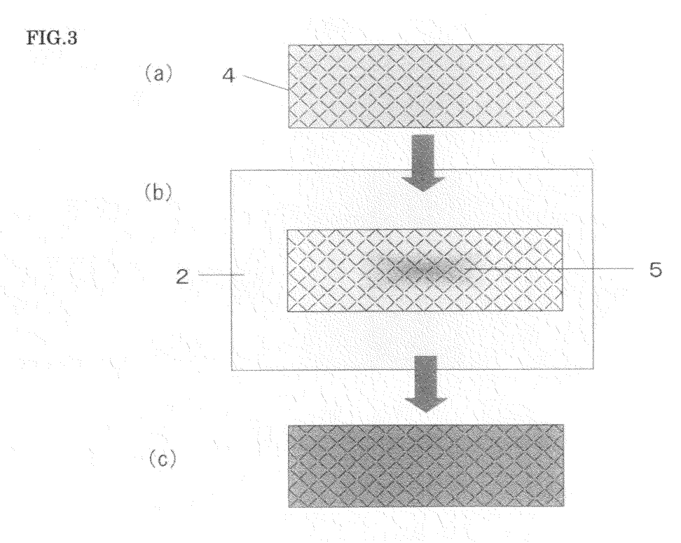

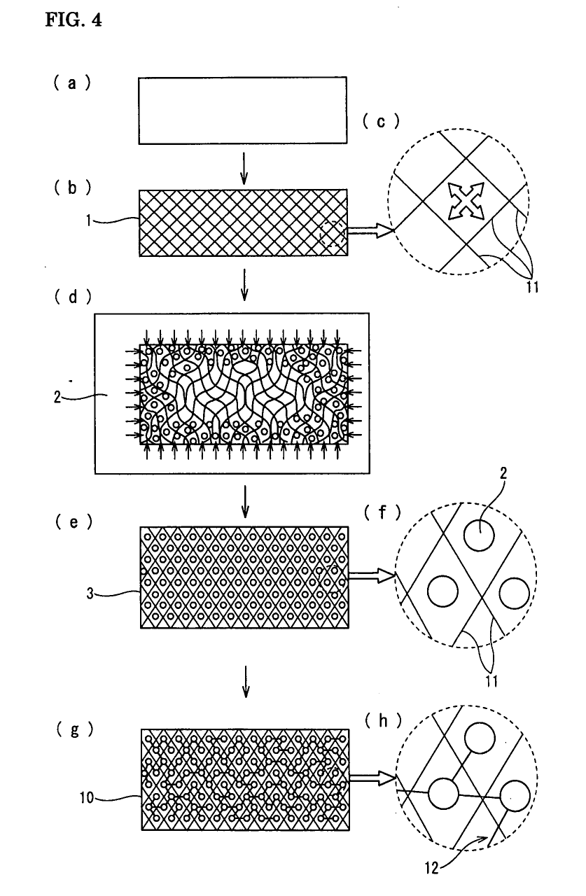

### REFERENCE NUMERALS

1 Cross-linked polylactic acid
2 Impregnant (cross-linking monomer (B))
3, 10 Polylactic acid complex
4 Polylactic acid molded product
5 Crystallization
11 Cross-links between polylactic acid chains
12 Cross-links between cross-linking monomer molecules

### BEST MODE FOR CARRYING OUT THE INVENTION

The first embodiment of the present invention is described below.

In the method of producing a polylactic acid complex according to the present invention, cross-linked polylactic acid is first prepared in the following procedures.

At first, polylactic acid is softened by heating, or dissolved or dispersed in any solvent that can dissolve polylactic acid, such as chloroform and cresol.

After that, the cross-linking monomer (A) is added. A particularly preferable cross-linking monomer (A) is TAIC. The content ratio of the cross-linking monomer in 100 parts by weight of polylactic acid is preferably 5 to 10 parts by weight.

The added cross-linking monomer (A) is uniformly dispersed by agitation and mixing.

Subsequently, the solvent is optionally removed by drying.

Thus the composition constituting a polylactic acid molded product is prepared.

The obtained composition is softened once again by heating or other means, and then molded into a molded product having a desired shape, such as a sheet, a film, fiber, a tray, a container and a bag. This step of molding the composition may be carried out, for example, with the composition being dissolved in the solvent or after cooling the composition or removing the solvent by drying.

As the next step, the obtained polylactic acid molded product is exposed to ionizing radiation for cross-linking to produce the cross-linked polylactic acid.

The ionizing radiation is preferably electron radiation generated using an electron linear accelerator.

The ionizing radiation dose falls within a range of 80 kGy to 100 kGy and is appropriately determined depending on the content ratio of the cross-linking monomer and other conditions. In particular, the ionizing radiation dose is determined so as to result in the polylactic acid complex having the gel fraction of substantially 100%.

The obtained cross-linked polylactic acid is immersed in an impregnant.

The impregnant used is ethyl alcohol, isopropyl alcohol, t-butyl alcohol or n-pentyl alcohol classified into polar alcohols; acetic acid classified into monovalent carboxylic acids; methyl ethyl ketone classified into ketones; γ-butyrolactone or ε-caprolactone classified into lactones; triallylisocyanurate classified into triazines; dimethylsulfoxide classified into polar aprotic solvents; “Lactcizer GP-4001,” a lactic acid-based plasticizer, manufactured by Arakawa Chemical Industries, Ltd.; “Lactcizer GP-2001,” a rosin-based plasticizer, manufactured by Arakawa Chemical Industries, Ltd.; triacetyl glyceride or acetylated monoglyceride (in particular, glycerin diacetomonolaurate) classified into glycerin derivatives; or adipate classified into dicarboxylic acid derivatives.

The temperature of the impregnant in which the cross-linked polylactic acid is immersed falls within the range of 65° C. to 100° C., preferably being a temperature at which the impregnant can remain in the liquid state.

The period of time for which the cross-linked polylactic acid is immersed in the impregnant is preferably 30 minutes to 90 minutes, and more preferably 60 minutes, when the thickness of the cross-linked polylactic acid is not larger than about 1 mm.

The polylactic acid complex according to the present invention can be obtained by cooling the cross-linked polylactic acid, which is in the swollen state because of the infiltration of the impregnant, to temperatures equal to or lower than the glass transition temperature of polylactic acid. In this cooling step, the cross-linked polylactic acid may be let stand at room temperature so as to be cooled slowly or rapidly cooled in water.

Next, the second embodiment of the present invention is described below.

In the method of producing a cross-linked polylactic acid complex according to the present invention, cross-linked polylactic acid is first prepared in the following procedures.

At first, polylactic acid is softened by heating, or dissolved or dispersed in any solvent that can dissolve polylactic acid, such as chloroform and cresol.

After that, the cross-linking monomer (A) is added. Similarly to the first embodiment, a particularly preferable cross-linking monomer (A) is TAIC. The content ratio of the cross-linking monomer in 100 wt % of polylactic acid is preferably in the range of 5 wt % to 7 wt %.

The added cross-linking monomer (A) is uniformly dispersed by agitation and mixing.

Subsequently, the solvent is optionally removed by drying.

Thus the composition constituting a polylactic acid molded product is prepared.

The obtained composition is softened once again by heating or other means, and then molded into a molded product having a desired shape, such as a sheet, a film, fiber, a tray, a container and a bag. This step of molding the composition may be carried out, for example, with the composition being dissolved in the solvent or after cooling the polylactic acid composition or removing the solvent by drying.

As the next step, the obtained polylactic acid molded product is subjected to primary cross-linking using ionizing radiation to produce the cross-linked polylactic acid.

The ionizing radiation is preferably electron radiation generated using an electron linear accelerator.

The ionizing radiation dose falls within a range of 80 kGy to 100 kGy and is appropriately determined depending on the content ratio of the cross-linking monomer and other conditions. In particular, the ionizing radiation dose is determined so as to result in the polylactic acid complex having the gel fraction of substantially 100%.

The obtained cross-linked polylactic acid is immersed in a cross-linking monomer (B).

The cross-linking monomer used is methacrylic acid or methyl methacrylate classified into methacrylic-type cross-linking monomers, TAIC classified into allylic-type cross-linking monomers, styrene classified into styrene-type cross-linking monomers, or ε-caprolactone classified into lactone-type cross-linking monomers.

The temperature of the cross-linking monomer (B) in which the cross-linked polylactic acid is immersed falls within the range of 65° C. to 100° C., and should be a temperature at which the cross-linking monomer (B) can remain in the liquid state. In addition, the period of time for which the cross-linked polylactic acid is immersed in the cross-linking monomer (B) is preferably 30 minutes to 90 minutes, and more preferably 60 minutes, when the thickness of the cross-linked polylactic acid is not larger than about 1 mm.

The cross-linked polylactic acid, which is in the swollen state because of the infiltration of the cross-linking monomer (B), is cooled to temperatures equal to or lower than the glass transition temperature of polylactic acid. In this cooling step, the cross-linked polylactic acid may be let stand at room temperature so as to be cooled slowly or rapidly cooled in water.

Subsequently, the cross-linked polylactic acid containing the cross-linking monomer (B) is subjected to secondary cross-linking using ionizing radiation, in which molecules of the cross-linking monomer (B) are cross-linked to each other and coupled with the surrounding polylactic acid chains via graft cross-linking, to produce the polylactic acid complex according to the present invention.

The ionizing radiation dose used in the secondary cross-linking step falls within the range of 30 kGy to 200 kGy and is appropriately determined depending on the kind and the content ratio of the cross-linking monomer and other conditions.

The polylactic acid complex according to the present invention produced in the abovementioned method contains the cross-linking monomer at high concentration. More specifically, the content ratio of the cross-linking monomer in polylactic acid is in the range of 15 wt % to 100 wt %, and more preferably in the range of 5 wt % to 50 wt %.

At the same time, the fixation ratio of the cross-linking monomer, which is measured in the method described in the examples below, is in the range of 5% to 95%, and more preferably in the range of 8% to 85%.

In the second embodiment of the present invention, the cross-linking monomers (A) and (B) are not separated out even when their content ratio is high as described above, because molecules of the cross-linking monomers have been cross-linked to each other or to the polylactic acid chains. Furthermore, the high concentration of the cross-linking monomers enhances the density of the cross-linking network, thus enabling the cross-linked polylactic acid molded product to still have the strength that is achieved at temperatures equal to or lower than 60° C., the glass transition temperature of polylactic acid, even at high temperatures equal to or higher than 60° C.

The downward bend angle of the polylactic acid molded product, which is an index of the strength and measured in the heat deformation test described in the examples below, is preferably smaller than 45°.

### EXAMPLES

The present invention is explained in detail below with reference to the examples and the comparative examples. However, the present invention is not limited to these examples.

### Examples 1 to 8

The pellet-like polylactic acid, LACEA H-400, manufactured by Mitsui Chemicals, Inc. was used as the polylactic acid. TAIC, a kind of allylic-type cross-linking monomers, was prepared and then added to the polylactic acid by melt-extruding the polylactic acid using an extruder (PCM30 manufactured by Ikegai, Ltd.) at the cylinder temperature of 180° C. while titrating the TAIC at a constant rate to the pellet supply portion of the extruder using a peristaltic pump. The ratio of the titration rate of the TAIC to the extrusion rate of the extruder was adjusted so that the content ratio of the TAIC is 7 parts by weight relative to 100 parts by weight of polylactic acid. The extruded product was cooled in water and then pelletized using a pelletizer to produce a pellet-like mixture of the polylactic acid and the cross-linking monomer.

This mixture was heat-pressed into a sheet at 160° C. and then rapidly cooled in water to obtain a sheet having a thickness of 500 μm.

This sheet was exposed to electron radiation of 100 kGy in an air-free inert gas using an electron linear accelerator (accelerating voltage 10 MeV, current 12 mA) to obtain cross-linked polylactic acid.

The obtained cross-linked polylactic acid is immersed in an impregnant at a temperature that is not lower than the glass transition temperature of polylactic acid and not higher than the melting point of polylactic acid.

The impregnant used is, as shown in Table I below, ethyl alcohol, isopropyl alcohol, t-butyl alcohol or n-pentyl alcohol classified into polar alcohols; γ-butyrolactone classified into lactones; triallylisocyanurate classified into triazines; “Lactcizer GP-4001,” a plasticizer containing a lactic acid derivative as its main ingredient, manufactured by Arakawa Chemical Industries, Ltd.; or “Lactcizer GP-2001,” a plasticizer containing a rosin derivative as its main ingredient, manufactured by Arakawa Chemical Industries, Ltd. The abovementioned cross-linked polylactic acid was immersed in ethanol at 70° C. or each of other impregnants at 80° C. contained in a constant temperature bath for one hour until it was in the swollen state. After that, the cross-linked polylactic acid is let stand at room temperature until cool to complete the polylactic acid complex according to the present invention.

### Examples 9 to 11

Examples 9 to 11 were prepared in the same procedures as those used in Examples 1, 2 and 7 except that the electron radiation dose was 50 kGy.

### Examples 12 to 19

The electron radiation dose was 100 kGy and the following impregnants were used. The production method was the same as that used in Examples 1 to 11.

Example 12: Dimethylsulfoxide (DMSO)

Example 13: Acetic Acid

Example 14: ε-caprolactone (1,6-lactone 6-hydroxyhexanoate, “PLACCEL M” manufactured by Daicel Chemical Industries, Ltd.)

Example 15: Methyl Ethyl Ketone

Example 16: Triacetyl glyceride (a glycerin derivative, “Triacetin” manufactured by Yuki Gosei Kogyo Co., Ltd.)

Example 17: Adipate (a dicarboxylic acid derivative, “DAIFFATY-101” manufactured by Daihachi Chemical Industry Co., Ltd.)

Example 18: Diacetyl monoglyceride (a glycerin derivative, “RIKEMAL PL-019” manufactured by Riken Vitamin Co., Ltd.)

Example 19: Acetylated polyglyceride (a glycerin derivative, “RIKEMAL PL-710” manufactured by Riken Vitamin Co., Ltd.)

### Comparative Examples 1 to 16

Comparative Examples 1 to 8 were prepared in the same procedures as those used in Examples 1 to 8 except that the TAIC was not added.

Also, Comparative Examples 9 to 16 were prepared in the same procedures as those used in Examples 1 to 8 except that the irradiation of electron radiation was omitted.

The examples and comparative examples were evaluated for the gel fraction of the cross-linked polylactic acid before being immersed in the impregnant according to the following method, and also for the content ratio of impregnant in the polylactic acid complex after being immersed in the impregnant according to the method described later.

### [Evaluation of the Gel Fraction]

The dry mass of each of the cross-linked polylactic acid samples was accurately measured, and then each sample was wrapped in a 200-mesh stainless steel mesh, boiled in chloroform for 48 hours to obtain the gel separated from the sol dissolved in the chloroform. Each gel was dried at 50° C. for 24 hours to remove chloroform remaining in the gel, and then the dry mass of the gel was measured. Based on the measured dry mass, the gel fraction was calculated in accordance with the following equation.

Gel fraction (%)=(Dry mass of the gel/Dry mass of the cross-linked polylactic acid)×100

### [Evaluation of the Content Ratio of Impregnant]

The mass of each cross-linked polylactic acid sample was measured at room temperature before the sample was immersed in the impregnant and after the immersed sample was cooled to room temperature. Based on the measured mass, the content ratio of impregnant was calculated in accordance with the following equation.

Content ratio of impregnant (%)={(A·B)/A}×100

where A represents the mass of the polylactic acid complex sample; and B represents the mass of the cross-linked polylactic acid sample before being immersed in the impregnant.

The following table shows the results obtained in the tests described above and the production conditions used.

TABLE I

| | | | | Gel fraction of the | | |
|---|---|---|---|---|---|---|
| | | | | cross-linked | | |
| | | Electron | | polylactic acid | | Content ratio of |
| | | radiation dose | | sample tested | Impregnant | impregnant |
| Example | 1 | 100 | kGy | 100% | Ethyl alcohol | 17% |
| | 2 | | | | Isopropyl alcohol | 19% |
| | 3 | | | | t-butyl alcohol | 26% |
| | 4 | | | | n-pentyl alcohol | 9% |
| | 5 | | | | γ-butyrolactone | 58% |
| | 6 | | | | Triallylisocyanurate | 20% |
| | 7 | | | | GP-4001 | 47% |
| | 8 | | | | GP-2001 | 6% |
| | 9 | 50 | kGy | | Ethyl alcohol | 16% |
| | 10 | | | | Isopropyl alcohol | 14% |
| | 11 | | | | GP-4001 | 37% |
| | 12 | 100 | kGy | | Dimethylsulfoxide | 47% |
| | 13 | | | | Acetic acid | 50% |
| | 14 | | | | ε-caprolactone | 35% |
| | 15 | | | | Methyl ethyl ketone | 46% |
| | 16 | | | | Triacetin | 54% |
| | 17 | | | | DAIFFATY-101 | 38% |
| | 18 | | | | PL-019 | 35% |
| | 19 | | | | PL-710 | 40% |
| Comparative | 1 | 100 | kGy | 0% | Ethyl alcohol | *1 |
| Example | 2 | | | | Isopropyl alcohol | *1 |
| | 3 | | | | t-butyl alcohol | *2 |
| | 4 | | | | n-pentyl alcohol | *2 |
| | 5 | | | | γ-butyrolactone | *1 |
| | 6 | | | | Triallylisocyanurate | *1 |
| | 7 | | | | GP-4001 | *2 |
| | 8 | | | | GP-2001 | *2 |
| | 9 | 0 | kGy | | Ethyl alcohol | 0% |
| | 10 | | | | Isopropyl alcohol | 0% |
| | 11 | | | | t-butyl alcohol | 0% |
| | 12 | | | | n-pentyl alcohol | 0% |
| | 13 | | | | γ-butyrolactone | 0% |
| | 14 | | | | Triallylisocyanurate | 0% |
| | 15 | | | | GP-4001 | 0% |
| | 16 | | | | GP-2001 | 0% |

*1 The content ratio could not be measured because of the weight loss caused by partial melting.
*2 The sample was solidified into white crystals.

In all the examples, the polylactic acid complex containing the impregnant was obtained. These complexes were characterized in that they inherited the transparency of polylactic acid and the cross-linked product thereof.

Furthermore, the examples except for Example 8 exhibited flexibility comparable to that of a flexible polyvinyl chloride resin even at room temperature. In particular, the examples containing γ-butyrolactone, “Lactcizer GP-4001,” dimethylsulfoxide, acetic acid, ε-caprolactone, methyl ethyl ketone, “Triacetin,” “DAIFFATY-101,” “PL-019,” “PL-710” or polar alcohols displayed an excellent flexibility.

Compared with other kinds of polar alcohols, t-butyl alcohol was particularly favorable in terms of swellability. Furthermore, the content ratio of impregnant measured 24 hours after the impregnation was at least 80% of the value measured immediately after the impregnation even in the polylactic acid complex containing ethanol, which is likely to evaporate at room temperature in many cases, thus demonstrating that the polylactic acid complex according to the present invention has a favorable containability.

As for the plasticizers for polylactic acid, the content ratio of “Lactcizer GP-4001,” a lactic acid-based plasticizer, was significantly higher than that of “Lactcizer GP-2001,” a rosin-based plasticizer. Accordingly, “Lactcizer GP-4001” improved the flexibility more effectively than “Lactcizer GP-2001.” “Triacetin,” “DAIFFATY-101,” “PL-019” and “PL-710” were superior to others in terms of odors because they were odorless while being contained in the complex. Among these impregnants, “DAIFFATY-101,” “PL-019” and “PL-710,” which showed no weight loss when heated to temperatures in the range of 100° C. to 120° C. and exhibited a higher flexibility than other impregnants contained at the same content ratio, are particularly suitable for achieving the objects of the present invention.

Examples 1, 2, 7 and 12 to 15, in which the electron radiation dose was 100 kGy, showed more uniform swelling with less deformation and higher content ratios of impregnant than Examples 9, 10 and 11, in which the electron radiation dose was 50 kGy. This may be attributable to the fact that the cross-linking densities of these examples differ from each other though their gel fractions measured in chloroform are 100% and identical to each other. The examples in which the electron radiation dose was 100 kGy exhibited higher cross-linking densities than others, thus yielding better results.

On the other hand, in Comparative Examples 1 to 16, wherein polylactic acid chains have not been cross-linked, the impregnant did not infiltrate the polylactic acid but partly dissolved the polylactic acid. Furthermore, they were crystallized and hardened when exposed to temperatures equal to or higher than the glass transition temperature and at the same time, obviously whitened because light was diffusely reflected in the crystal so as not to come out of the crystal.

Examples 18 and 19 were evaluated for bleed.

In this test, bleed caused by heating was quantified by measuring the change in weight of the samples held in a constant temperature bath at 80° C. The result was shown in FIG. 6. As seen in FIG. 6, in Example 18, the content ratio of impregnant PL-019 was reduced by approximately 5% in 360 hours (15 days), whereas in Example 19, the content ratio of impregnant PL-710 was reduced by only approximately 1%. This result confirmed that bleed was unlikely to occur in these complexes. Also, the complexes still had flexibility and transparency.

### Examples 20 to 23

The pellet-like polylactic acid, LACEA H-400, manufactured by Mitsui Chemicals, Inc. was used as the polylactic acid. TAIC, a kind of allylic-type cross-linking monomers, was prepared and then added to the polylactic acid by melt-extruding the polylactic acid using an extruder (PCM30 manufactured by Ikegai, Ltd.) at the cylinder temperature of 180° C. while titrating the TAIC at a constant rate to the pellet supply portion of the extruder using a peristaltic pump. The ratio of the titration rate of the TAIC to the extrusion rate of the extruder was adjusted so that the content ratio of the TAIC is 7 parts by weight relative to 100 parts by weight of polylactic acid. The extruded product was cooled in water and then pelletized using a pelletizer to produce a pellet-like mixture of the polylactic acid and the cross-linking monomer (A).

This mixture was heat-pressed into a sheet at 160° C. and then rapidly cooled in water to obtain a sheet-like polylactic acid molded product having a thickness of 500 μm.

This sheet-like polylactic acid molded product was exposed to electron radiation of 100 kGy in an air-free inert gas using an electron linear accelerator (accelerating voltage 10 MeV, current 12 mA) to obtain cross-linked polylactic acid.

The obtained cross-linked polylactic acid is immersed in a cross-linking monomer (B) at a temperature that is not lower than the glass transition temperature of polylactic acid and not higher than the melting point of polylactic acid. As the cross-linking monomer (B), methacrylic acid was used. More specifically, the abovementioned cross-linked polylactic acid was immersed and in methacrylic acid contained in a constant temperature bath at 80° C. for one hour until it was in the swollen state.

After that, the cross-linked polylactic acid was cooled to room temperature. After the removal of the residual monomer by wiping, the cross-linked polylactic acid was vacuum-packed and then exposed to electron radiation of 30 kGy, 60 kGy, 100 kGy or 200 kGy using an electron linear accelerator (accelerating voltage 10 MeV, current 12 mA). Then the cross-linked polylactic acid was subjected to vacuum drying for 24 hours for removing the residual unfixed monomer. In this way, the polylactic acid complex according to the present invention was completed.

### Examples 24 to 29

Examples 24 to 29 were prepared in the same procedures as those used in Example 20 except that TAIC, styrene, ε-caprolactone, methyl methacrylate, trimethylolpropane methacrylate (hereinafter, TMPTMA) and trimethylolpropane acrylate (hereinafter, TMPTA) are respectively used instead of methacrylic acid as the cross-linking monomer (B) in which the cross-linked polylactic acid was immersed.

### Comparative Examples 17 and 18

Comparative Example 17 was prepared in the same procedures as those used in Examples 20 to 23 except that the second and third steps, i.e., the impregnation of the cross-linking monomer (B) and the secondary cross-linking, were omitted.

Comparative Example 18 was prepared in the same procedures as those used in Examples 20 to 23 except that the first irradiation of electron radiation was omitted and the electron radiation dose used in the second irradiation was 90 kGy.

The examples and comparative examples were evaluated for the gel fraction of the cross-linked polylactic acid before being immersed in the cross-linking monomer (B) according to the method described earlier, and also for the fixation ratio of the cross-linking monomer (B), heat deformation and transparency of the final product, polylactic acid complex, according to the following methods.

[Evaluating the Fixation Ratio of the Cross-Linking Monomer]

The mass of each cross-linked polylactic acid sample was measured at room temperature before the sample was immersed in the cross-linking monomer (B) and the mass of the final product, polylactic acid molded product, was measured later. Based on the measured mass, the fixation ratio of the cross-linking monomer was calculated in accordance with the following equation.

Fixation ratio of the cross-linking monomer (%)={(B−A)/A}×100

where A represents the mass of the cross-linked polylactic acid before being immersed in the cross-linking monomer (B); and B represents the mass of the polylactic acid complex sample.

### [Evaluation of the Heat Deformation]

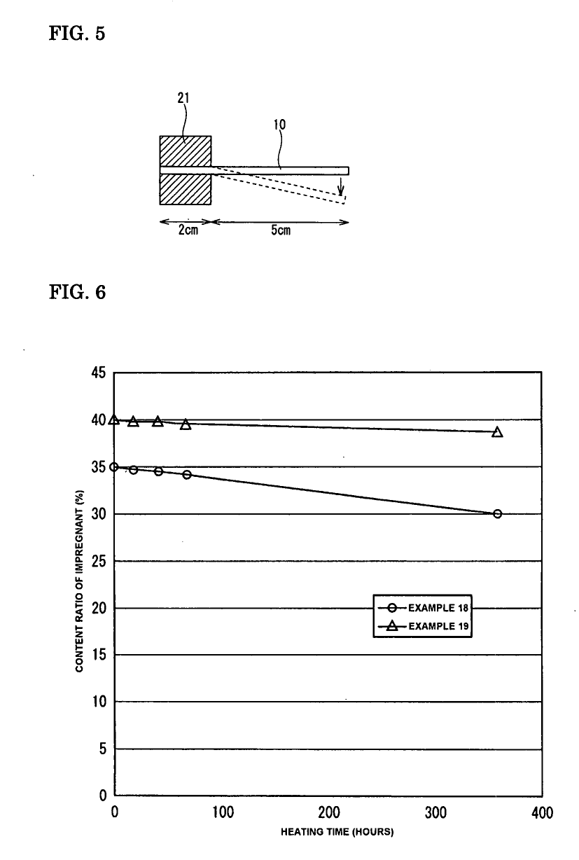

Each of the polylactic acid complexes was cut into a strip sample measuring 1 cm in width and 7 cm in length. To measure the downward deformation caused by gravity, each sample was let stand in a constant temperature bath at 100° C. for one hour while being held at 2 cm away from its end and kept in a horizontal position by a test device 21 as shown in FIG. 5.

In FIG. 5, the solid line represents the polylactic acid complex 10 before the test, and the dashed line represents the polylactic acid complex 10 deformed downward by gravity during the test.

When the angle of downward bend was 1° or smaller and no deformation was found, the evaluation was [symbol] ; when the angle of downward bend was smaller than 5°, the evaluation was “◯”; when the angle of downward bend was not smaller than 5° and smaller than 45°, the evaluation was “Δ”; and when the angle of downward bend was 450 or larger, the evaluation was “x.”

[Transparency]

When the resulting cross-linked polylactic acid molded product inherited the transparency of the raw material, polylactic acid, the evaluation was “◯”; when the molded product was partly opacified, the evaluation was “Δ”; and when the molded product was whitened, the evaluation was “x.”

The following table shows the results obtained in the tests described above and the production conditions used.

TABLE II

| | | Electron radiation | | | | | | |
|---|---|---|---|---|---|---|---|---|
| | | dose | | | Gel fraction of the | Fixation ratio | | |
| | | Primary | | | polylactic acid | of the cross- | | |
| | | cross- | Secondary | Cross-linking | after primary | linking | Heat | |
| | | linking | cross-linking | monomer | cross-linking | monomer | deformation | Transparency |
| Example | 20 | 100 kGy | 30 kGy | Methacrylic acid | >99% | 65% | ◯ | ◯ |
| | 21 | | 60 kGy | | | 69% | [symbol] | ◯ |
| | 22 | | 100 kGy | | | 78% | [symbol] | ◯ |
| | 23 | | 200 kGy | | | 86% | [symbol] | ◯ |
| | 24 | | 100 kGy | Triallylisocyanurate | | 15% | Δ | ◯ |
| | 25 | | | Styrene | | 18% | ◯ | Δ |
| | 26 | | | ε-caprolactone | | 8% | Δ | ◯ |
| | 27 | | | Methyl methacrylate | | 45% | [symbol] | ◯ |
| Comparative | 17 | | 0 kGy | — | | — | X | ◯ |
| Example | 18 | 0 kGy | 90 kGy | Methacrylic acid | <1% | <1% | X | X |
| Example | 28 | 100 kGy | 100 kGy | Trimethylolpropane | >99% | 35% | ◯ | ◯ |
| | | | | methacrylate | | | | |
| | 29 | 100 kGy | | Trimethylolpropane | >99% | 75% | [symbol] | ◯ |
| | | | | acrylate | | | | |

In all the examples, the polylactic acid complex wherein molecules of the cross-linking monomer (B) had been fixed via cross-linking was obtained. Considering that the unfixed cross-linking monomer (B) had been removed by drying in vacuum for 24 hours, it is clear that the molecules of the cross-linking monomer (B) were graft-polymerized in polylactic acid or formed cross-links.

The first feature of the polylactic acid complex according to the present invention is that it is not deformed even at high temperatures equal to or higher than the glass transition temperature of polylactic acid. The second feature is that it inherits the almost complete transparency of polylactic acid and the cross-linked product thereof, though Example 25 was partly opacified.

In particular, the methacrylic-type cross-linking monomers, such as methacrylic acid and methyl methacrylate, and the acrylic-type cross-linking monomers, such as TMPTA, showed fixation ratios as high as 45% to 86%. This demonstrates that these kinds of monomers have an excellent capability of maintaining the strength of the product at high temperatures and outstanding transparency, thus being most suitable for achieving the objects of the present invention.

On the other hand, in Comparative Example 17, in which polylactic acid was subjected only to primary cross-linking and the impregnation of the cross-linked polylactic acid in the cross-linking monomer (B) and the secondary cross-linking were omitted, the product strength at a high temperature was not improved.

In Comparative Example 18, in which the polylactic acid molded product was cross-linked only after being immersed in the cross-linking monomer (B), the cross-linking monomer (B) did not infiltrate the polylactic acid but partly dissolved the polylactic acid. Furthermore, it was crystallized and hardened when exposed to temperatures equal to or higher than the glass transition temperature and at the same time, obviously whitened because light was diffusely reflected in the crystal so as not to come out of the crystal.

1. A method of producing a polylactic acid complex, wherein cross-linked polylactic acid is combined with an impregnant in steps comprising:
a primary cross-linking step wherein the cross-linked polylactic acid is formed by cross-linking a polylactic acid molded product;
an impregnation step wherein the cross-linked polylactic acid is immersed in the impregnant at a temperature that is not lower than the glass transition temperature of polylactic acid and not higher than the melting point of polylactic acid so that the impregnant infiltrates the cross-linked polylactic acid; and
a cooling step wherein the cross-linked polylactic acid, which is in the swollen state because of the infiltration of the impregnant, is cooled to temperatures equal to or lower than the glass transition temperature.

2. The method of producing a polylactic acid complex according to claim 1, wherein a composition used for forming the polylactic acid molded product contains no plasticizer.

3. The method of producing a polylactic acid complex according to claim 1, wherein a composition used for forming the polylactic acid molded product contains a cross-linking monomer (A).

4. The method of producing a polylactic acid complex according to claim 3, wherein the cross-linking monomer (A) is an allylic-type cross-linking monomer, and the allylic-type cross-linking monomer is mixed with 100 parts by weight of polylactic acid at a content ratio of 4 to 15 parts by weight.

5. The method of producing a polylactic acid complex according to claim 3, wherein a cross-linking monomer (B) is used as the impregnant, and the cooling step is followed by a secondary cross-linking step wherein the cross-linked polylactic acid infiltrated by the cross-linking monomer (B) is further cross-linked.

6. The method of producing a polylactic acid complex according to claim 5, wherein the cross-linking monomer (B) is a methacrylic acid-type monomer, a styrene-type monomer, an allylic-type monomer or a lactone-type monomer.

7. The method of producing a polylactic acid complex according to claim 1, wherein the cross-linked polylactic acid is formed by exposing the polylactic acid molded product to ionizing radiation in the primary cross-linking step.

8. The method of producing a polylactic acid complex according to claim 7, wherein the dose of the ionizing radiation is in the range of 50 kGy to 200 kGy.

9. The method of producing a polylactic acid complex according to claim 5, wherein cross-linking reactions in the primary and secondary cross-linking steps are initiated by irradiation of ionizing radiation; polylactic acid chains are cross-linked to each other in the primary cross-linking step; and molecules of the cross-linking monomer (B), which has infiltrated the cross-linked polylactic acid in the impregnation step, are cross-linked to each other and graft cross-linked to polylactic acid chains.

10. A polylactic acid complex produced by the method according to claim 1, wherein the impregnant infiltrates a polylactic acid cross-linking network.

11. The polylactic acid complex according to claim 10, wherein a polylactic acid component is cross-linked in such a manner that the gel fraction thereof is substantially 100%.

12. The polylactic acid complex according to claim 10, which shows no thermal absorption at the glass transition temperature of polylactic acid and no thermal absorption associated with crystal melting at temperatures around the melting point of polylactic acid in a calorimetrical analysis performed over the temperature range of 40° C. to 200° C. using a differential scanning calorimeter.

13. The polylactic acid complex according to claim 10, wherein the content ratio of the impregnant is in the range of 5% to 60%.

14. The polylactic acid complex according to claim 10, wherein the impregnant comprises at least one of following (a) to (g):
(a) polar monovalent alcohols, monovalent carboxylic acids, ketones or lactones;
(b) polar aprotic solvents such as N,N-dimethylformamide and dimethylsulfoxide (DMSO);
(c) polar aromatic compounds such as styrene;
(d) allylic compounds having a triazine ring;
(e) plasticizers containing a polylactic acid derivative or a rosin derivative;
(i) plasticizers containing a dicarboxylic acid derivative; and
(g) plasticizers containing a glycerin derivative.

15. A polylactic acid complex produced by the method according to claim 5.

16. The polylactic acid complex according to claim 15, wherein a complicated cross-linking network having cross-linking of the polylactic acid and cross-linking of the cross-linking monomer (B) is formed by cross-linking polylactic acid chains to each other in such a manner that the gel fraction thereof is substantially 100% and then cross-linking molecules of the cross-linking monomer (B), which has infiltrated the cross-linked polylactic acid in the impregnation step, to each other.
